(19) United States
(12) Patent Application Publication
(10) Pub. No.: US 2008/0120207 A1
(43) Pub. Date: May 22, 2008

(54) Method and system for electronically managing product inventory using a database

(76) Inventor: Ronnie D. Strickland, Evergreen, NC (US)

Correspondence Address: P.JEFF MARTIN OF THE McGOUGAN LAW FIRM, LLC;SUITE 200, 2120 SEA MOUNTAIN HWY, P.O.BOX 4369, N. MYRTLE BEACH, SC, 29597, US

(21) Appl. No.: 11/602,670

(22) Filed: Nov. 21, 2006

(51) Int. Cl. G06Q 10/00

(52) U.S. Cl. 705/28

(57) ABSTRACT

A method, system, and machine-readable medium for providing targeted information in relation to pharmaceutical product inventory management is disclosed. The system is adapted to manage an entity's outpatient medication inventory without the need for maintaining a separate inventory in a manner which is quick, easy, and efficient.

### RELATED APPLICATIONS

The present invention was first described in Disclosure Document No. 588,738 filed on Oct. 27, 2005 under 35 U.S.C. §122, 37 C.F.R. §1.14, and MPEP §1706. It is respectfully requested that said Disclosure Document remain a permanent part of the file history of the present application and be relied upon during the pending prosecution, and for any other matters that may arise concerning said present application and the subject matter contained therein. There are no previously filed, nor currently any co-pending applications, anywhere in the world.

### BACKGROUND OF THE INVENTION

1. Field of the Invention

The present invention relates generally to the field of information processing. More specifically, the present invention relates to a method, apparatus, system, and machine-readable medium for providing targeted information in relation to product inventory management.

2. Description of the Related Art

Modern medicine greatly depends on the use of medications for the treatment and control of medical conditions. Today, the typical pharmacy and other medical entities must maintain a stock of approximately 4,000 to 6,000 different medications to meet routine demands.

The most important aspect of hospital and institutional pharmacy operations is the delivery of pharmaceuticals from the dispensing entity to the patient. Medication distribution involves numerous modalities such as physician order entry interfaces, distribution, inventory control, tracking, pricing updates, inventory reports, and the like. Currently, drug inventory management is facilitated by various methods and systems. However, none of these methods or systems are adapted to manage an entity's outpatient drug inventory without the need for maintaining a separate inventory.

A search of the prior art did not disclose any patents that read directly on the claims of the instant invention; however, the following references were considered related:

U.S. Pat. No. 4,847,764, issued in the name of Halvorson discloses a system for dispensing drugs in health care institutions which includes a computer system connected to control a plurality of remote medication dispensers. Pharmacy terminals are provided for entering medication orders and software in the computer system controls the dispensers to dispense medications according to the orders specified. The system includes support for dispensing medications from floor stocks. In either case, medications are administered in accordance with instructions from the computer system generated in accordance with said orders. The system further includes software for identifying medication duplications and potentially dangerous drug interactions based on orders entered into the system at the pharmacy. Inventory control and restocking features are also provided.

U.S. Pat. No. 5,737,539, issued in the name of Edelson et al. discloses a prescription creation system which is an electronic prescription creation system for use by professional prescribers at the point of care having a prescription division subsystem permitting creation of a single prescription to be automatically divided into two components for fulfillment of one portion quickly and locally at higher cost and of another portion by remote mail order taking more time but providing a cost saving for a major part of the prescription. The prescription creation system has an ability to access remote source databases for system presentation to the prescriber of relevant, authorized and current drug, drug formulary and patient history information, with dynamic creation of a transient virtual patient record, the information being presented to the prescriber before completion of the prescription, permitting enhancement of the quality of prescribing decisions.

U.S. Pat. No. 5,845,255, issued in the name of Mayaud discloses a prescription management system in which a wirelessly deployable, electronic prescription creation system is shown for physician use that captures into a prescription a patient condition-objective of the prescribed treatment and provides for patient record assembly from source elements, with privacy controls for patient and doctor, adverse indication review and online access to comprehensive drug information including scientific literature. Extensions to novel multi-drug packages and dispensing devices, and an “intelligent network” remote data retrieval architecture as well as onscreen physician-to-pharmacy and physician-to-physician e-mail are also provided.

U.S. Patent Application no. 2002/0032582 A1, published in the name of Feeney discloses a system for medication dispensing and integrated data management which can include a medical office system with at least one computer which can be linked to at least one server and a central system through a network. The medical office computer also can communicate with at least one controlled dispenser unit, thereby regulating the dispensing of medication. Information pertaining to patients and/or medications can be transmitted and received by each system component.

Consequently, a need has arisen for a method, apparatus, system, and machine-readable medium for providing targeted information in relation to product inventory management in a manner which is quick, easy, and efficient.

### SUMMARY OF THE INVENTION

In one aspect described herein, a method, system, apparatus and computer readable medium is disclosed, the embodiments providing for electronically managing product inventory using a database, wherein the method comprising the steps of populating a database field of the database with the dispensed quantity of at least one product. The database performs the steps of: calculating the total inventory quantity remaining of the at least one product;populating the database with the total inventory quantity remaining of the at least one product; calculating the replenish quantity of the at least one product required to replenish the at least one product inventory to a defined quantity; and populating the database with the replenish quantity of the at least one product.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a diagram of a system in accordance with the embodiments described herein;

FIG. 2 is a representation of one embodiment of a database utilized in the system depicted in FIG. 1 and described herein; and

FIG. 3 is a flow chart of the method and steps comprising the use of the system depicted in FIG. 1, the database of FIG. 2, and described throughout.

### DESCRIPTION OF THE PREFERRED EMBODIMENTS

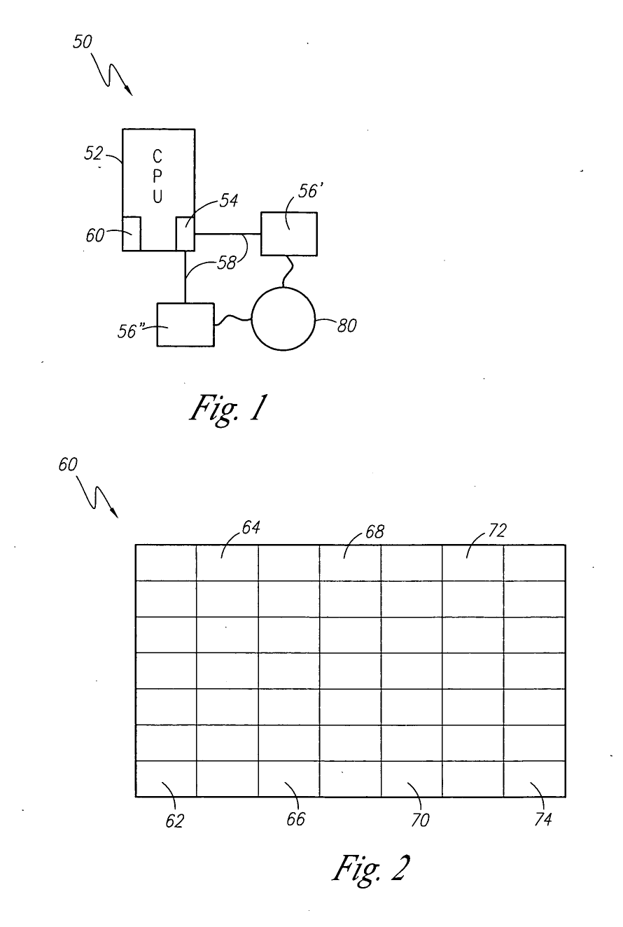

The best mode for carrying out the invention is presented in terms of its preferred embodiment, herein depicted within the FIG. 1 through FIG. 3.

The present invention may be implemented using hardware, software or a combination thereof and may be implemented in one or more computer systems or other processing systems. In one embodiment, the invention is directed toward one or more computer systems capable of carrying out the functionality described herein.

A computer system(s) may include one or more processors, such as processor operatively coupled to a communication infrastructure (e.g., a communications bus, cross-over bar, or network). Various software embodiments are described in terms of this exemplary computer system. The computer system(s) may include a display interface that forwards graphics, text, and other data from the communication infrastructure (or from a frame buffer not shown) for display on the display unit (such as a terminal monitor or other visual aid). The computer system may also includes a main memory, preferably random access memory (RAM), and may also include a secondary memory, such as a hard disk drive, a removable storage drive, representing a floppy disk drive, a magnetic tape drive, an optical disk drive, and any kind of memory for permanent and/or temporary storage, including floppy and/or portable disks, conventional hard disks, CD-ROMS, Flash disks or drives, Flash ROMS, nonvolatile ROM and RAM. Other forms of secondary memory may include other similar devices for allowing computer programs or other instructions to be loaded into computer system. Such devices may include a removable storage unit and an interface. Examples of such may include a program cartridge and cartridge interface (such as that found in video game devices), a removable memory chip (such as an erasable programmable read only memory (EPROM), or programmable read only memory (PROM) and associated socket, and other removable storage units and interfaces, which allow software and data to be transferred from the removable storage unit to the computer system(s).

The computer system may also include a communications interface that allows software and data to be transferred between the computer system(s) and external devices. Examples of communications interface may include a modem, a network interface (such as an Ethernet card), a communications port, a Personal Computer Memory Card International Association (PCMCIA) slot and card, etc. Software and data transferred via communications interface are in the form of signals, which may be electronic, electromagnetic, optical or other signals capable of being received by communications interface. These signals are provided to communications interface via a communications path that carries signals and may be implemented using wire or cable, fiber optics, a telephone line, a cellular link, a radio frequency (RF) link and/or other communications channels.

As used herein, the terms “computer program medium” and “computer usable medium” are used to refer generally to media such as a removable storage drive, a hard disk installed in hard disk drive, and signals. These computer program products provide software to the computer system(s).

The computer programs, when executed, enable the processor to perform the features of the present invention. Accordingly, such computer programs represent controllers of the computer system.

The method, system, apparatus and selected media formats may be implemented using a combination of both hardware and software.

The method, system, apparatus and selected media formats may be used with any machine-readable and/or computer-readable medium having any kind of memory for permanent and/or temporary storage, including floppy and/or portable disks, conventional hard disks, CD-ROMS, Flash disks or drives, Flash ROMS, nonvolatile ROM and RAM.

Referring now to FIG. 1 through FIG. 2, one envisioned embodiment of a system and configuration 50 for providing management of product inventory for at least one and/or multiple products, wherein the product(s) may include any variety of physical/tangible assets retained for future distribution. In one envisioned embodiment, and the example used herein, the product(s) is/are pharmaceutical products retained by an authorized pharmaceutical dispensing agent, such as a conventional pharmacy (proprietary or franchise) or a hospital pharmacy. In one aspect of managing product inventory of pharmaceutical products or agents, the system 50 comprises computer executable instructions that interacts with a central processing unit (cpu) 52 and a communications port (com port) 54 for the transmission of information from device to device (such as a plurality of workstations). The com port 54 communicates with a plurality of computer workstations 56′ and 56″ through serial cables 58. User will utilize a database 60 within the system 50 that is installed onto the cpu 52 or a device that communicates with the cpu 52, wherein the user populates a database field 62 of the database by manually or electronically entering the dispensed quantity of at least one product. The database 60 may comprise a variety of forms, and is envisioned to include at least the following fields: product field 62, initial quantity 64 of the specific product inventory, dispensed quantity 66 of the specific product inventory, the final or remaining quantity 68 of the specific product inventory for a defined interval of time, also referred to as a “carryover”. The database 60 may also include additional fields, such as: packages dispensed 70, quantity within the individual packages 72, and a field to indicate whether the product supply should be replenished (automatically or manually generated, usually answered by “YES” or “NO”) 74.

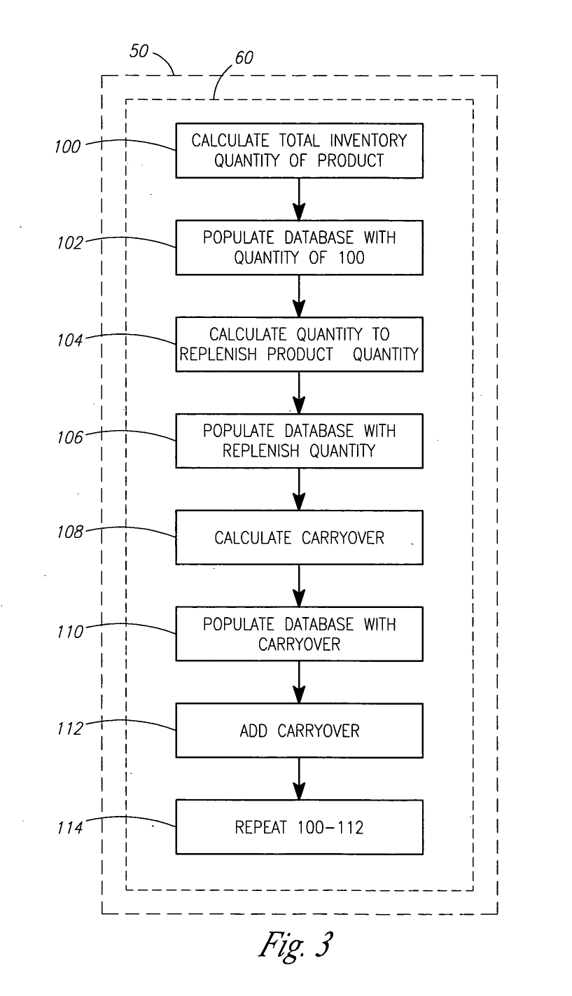

Referring now to FIG. 3, the database 60 performs the steps of calculating the quantity (referred to as the “total inventory quantity”) remaining 100 of the at least one product, and then populating the database with the total inventory quantity remaining 102 of the at least one product. The database then automatically calculates the quantity (referred to as the “replenish quantity”) 104 of the at least one product required to replenish the at least one product inventory to a defined quantity (explained in greater detail below). The database may then populate 106 the database with the replenish quantity of the at least one product. The database may then be used to calculate the quantity of excess inventory (referred to as the “excess inventory quantity”) 108 remaining for a defined interval (explained in greater detail below) for the at least one product. The database may then be used to populate the database with the carryover quantity 110. The database may also be used to add the excess inventory quantity 112 to the replenish quantity of the at least one product so as to generate a carryover quantity. Steps 100-112 may be repeated for another defined interval, and may be repeated 114 for each individual product for which management is desired.

The identifying characteristics of the inventory are manually entered by the user using a narrative format or, for example using pre-drafted text selected from a series of choices displayed in a drop down menu, provided by radio buttons, or selectable in conjunction with other methods of presenting multiple choices known in the art.

The defined interval is envisioned as a measurable time period determined by the particular pharmacy for tracking the quantity of pharmaceutical products or agents dispensed for strategic planning in replenishing the supply of the specific product(s). The defined interval is envisioned as being somewhat dependent upon the quantity of product(s) demanded by patients and/or customers, so that there is flexibility in setting the interval and providing for greater efficiency in restocking a product(s) supply. For instance, the defined interval could be as narrow as a day or twenty-four hour period under certain circumstances, such as a hospital or department that specializes in treating patients suffering from the same or similar ailments. It is envisioned that more common intervals of a week, a month, a quarter of a year, or a year are likely intervals that may be utilized. Other intervals that are envisioned include bimonthly (including both usual definitions—twice a month and once every two months, respectively) and other increments of the larger intervals noted above.

It is envisioned that the pharmacy will desire to set a defined quantity or a ceiling for each product that will be monitored by the system. In a multi-product environment, each product would have a different ceiling limit taking into account the dosage amounts available by the manufacturer, the typical dosage amounts used in treatment schemes, quantities of the product provided by the manufacturer, the number of patients that generally require the particular pharmaceutical, and other similar considerations. The user will manually enter the defined quantity for each into the database so that the other data fields and the database generally has a reference point for calculating any reduction in the preexisting inventory and providing a value for indicating the quantity of the product(s) that should be ordered to replenish and restock the supply. The database may provide a floor quantity. If the remaining quantity of the product falls below the floor quantity, the database and/or a separate program associated with the database may trigger the release of a warning message or notice to indicate that replenishment of the product is immediately necessary.

Once the user has entered and the database has updated the data fields to accurately reflect current inventory, the user may then generate a report(s) for evaluating previous defined intervals and perform other types of analysis that may be desired.

Functionally, the user accesses the product inventory information via a terminal 56′ or 56″, such as a personal computer (PC), minicomputer, mainframe computer, microcomputer, personal digital assistant (PDA), telephone device or other device having a processor, display, and input capability. The terminal 56′ or 56″ provides methods and systems for communication, including electronic media, allowing input by the user. In one example, the user accesses information using the terminal 56′ or 56″ via a network 80, such as the Internet, a Local Area Network (LAN), or a Wide Area Network (WAN). A user may also access information by accessing a server 52, such as a PC, minicomputer, mainframe computer, microcomputer, or other device having a processor and a repository for data or connection to a repository for maintained data, via the network and connections required.

The user utilizes a graphical user interface (GUI) to view, update, modify, track, or otherwise manage product inventory. In one example, inventory and order information, such as shipping work orders, is displayed via the GUI, allowing the user to perform a variety of functions, such as tracking inventory, viewing inventory, modifying inventory, and inventory totals, and exception reports.

As noted above, the present application and invention is not limited to the disclosure with regard to managing the inventory of pharmaceutical products or agents, as any type of product or asset may be monitored and managed in accordance with the system, method, apparatus and media described above.

As designed, a device embodying the teachings of the present invention is easily applied. The foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be broadly limited only by the following claims.

What is claimed is:

1. A method for electronically managing product inventory using a database, the method comprising the steps of:
populating a database field of the database with the dispensed quantity of at least one product, the database performing the steps of:
calculating the total inventory quantity remaining of the at least one product;
populating the database with the total inventory quantity remaining of the at least one product;
calculating the replenish quantity of the at least one product required to replenish the at least one product inventory to a defined quantity; and
populating the database with the replenish quantity of the at least one product.

2. The method of claim 1, the database further performing the steps of:
calculating the quantity of excess inventory remaining for a defined interval for the at least one product;
adding the quantity of excess inventory of the at least one product to the replenish quantity of the at least one product to generate a carryover quantity; and
populating the database with the carryover quantity.

3. The method of claim 2, wherein the defined interval comprises a calendar month.

4. The method of claim 2, wherein the defined interval comprises a week.

5. The method of claim 2, wherein the defined interval comprises a quarter of a calendar year.

6. The method of claim 1, wherein the defined quantity comprises a value substantially equivalent to a maximum quantity of the at least one product.

7. A computer-readable storage medium having computer-executable instructions executable by a digital processing apparatus for performing a method, the method comprising:
populating a database field of the database with the dispensed quantity of at least one product, the database performing the steps of:
calculating the total inventory quantity remaining of the at least one product;
populating the database with the total inventory quantity remaining of the at least one product;
calculating the replenish quantity of the at least one product required to replenish the at least one product inventory to a defined quantity; and
populating the database with the replenish quantity of the at least one product.

8. The method of claim 7, the database further performing the steps of:
calculating the quantity of excess inventory remaining for a defined interval for the at least one product;
adding the quantity of excess inventory of the at least one product to the replenish quantity of the at least one product to generate a carryover quantity; and
populating the database with the carryover quantity.

9. The method of claim 8, wherein the defined interval comprises a calendar month.

10. The method of claim 8, wherein the defined interval comprises a week.

11. The method of claim 8, wherein the defined interval comprises a quarter of a calendar year.

12. The method of claim 7, wherein the defined quantity comprises a value substantially equivalent to a maximum quantity of the at least one product.

13. A system for managing product inventory comprising:
a storage device;
a printer; and
a processor programmed to:
populate a database field of the database with the dispensed quantity of at least one product, the database performing the steps of:
calculate the total inventory quantity remaining of the at least one product;
populate the database with the total inventory quantity remaining of the at least one product;
calculate the replenish quantity of the at least one product required to replenish the at least one product inventory to a defined quantity; and
populate the database with the replenish quantity of the at least one product.

14. The system of claim 13, wherein the processor is further programmed to:
calculate the quantity of excess inventory remaining for a defined interval for the at least one product;
add the quantity of excess inventory of the at least one product to the replenish quantity of the at least one product to generate a carryover quantity; and
populate the database with the carryover quantity.

15. The system of claim 14, wherein the defined interval comprises a calendar month.

16. The system of claim 14, wherein the defined interval comprises a week.

17. The system of claim 14, wherein the defined interval comprises a quarter of a calendar year.

18. The system of claim 13, wherein the defined quantity comprises a value substantially equivalent to a maximum quantity of the at least one product.
